(19) United States
(12) Patent Application Publication
(10) Pub. No.: US 2014/0314242 A1
(43) Pub. Date: Oct. 23, 2014

(54) Ambient Sound Enablement for Headsets

(71) Applicant: PLANTRONICS, INC., Santa Cruz, CA (US)

(72) Inventors: Lawrence A. Gollbach, Ben Lomond, CA (US); Charles Frizelle, Scotts Valley, CA (US)

(73) Assignee: Plantronics, Inc., Santa Cruz, CA (US)

(21) Appl. No.: 13/866,539

(22) Filed: Apr. 19, 2013

(51) Int. Cl. H04R 3/00

(52) U.S. Cl. CPC H04R 3/002
USPC 381/71.6

(57) ABSTRACT

Methods and apparatuses for ambient sound enablement in headsets are disclosed. In one example, an ambient sound signal from a microphone is received. A pre-determined interrupt condition is identified from the ambient sound signal. The ambient sound signal is output at a headset speaker responsive to identifying the pre-determined interrupt condition.

### BACKGROUND OF THE INVENTION

As electronic and mobile devices proliferate, the use of headsets has increased. Headsets are often worn by people while listening to music, playing video games, or conducting telephone conversations. For example, it is not uncommon to see a person walking on the street or riding public transportation while wearing large headphones to listen to music or conduct a telephone call. While performing these activities, the headset user desires to be isolated from their environment so they can focus on the activity they are currently engaged in. Thus, headsets are often designed to block ambient noise in the surrounding environment from being heard. While this can be desirable to the user, it can pose safety or undesirable situations for the headset user and/or for other people trying to attract the attention of the intensive user.

In the prior art, certain headsets have typically tried to address this problem by providing an open architecture in the headset design to allow ambient sound to enter the receive channel or certain automatic noise reduction (ANR) headsets port in the external sound to the receive (Rx) channel as a manually selectable user feature. However, these solutions either defeat the user's desire to be isolated from their environment or the user selectable feature isn't turned on when the external stimulus is trying to contact an occupied unaware user.

As a result, improved methods and apparatuses for addressing desirable ambient sound in headsets are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for ambient sound interrupt in one example.

FIG. 2 illustrates a system for ambient sound interrupt in one example of the system shown in FIG. 1.

FIG. 3 illustrates an example implementation of the ambient sound interrupt system shown in FIG. 1.

FIG. 4 illustrates an example implementation of the system for ambient sound interrupt shown in FIG. 1.

FIG. 5 illustrates a further example implementation of the system for ambient sound interrupt shown in FIG. 1.

FIG. 6 illustrates a further example implementation of the system for ambient sound interrupt shown in FIG. 1.

FIG. 7 illustrates a sample data structure storing interrupt words utilized by the ambient sound interrupt system.

FIG. 8 illustrates a sample data structure storing interrupt phrases utilized by the ambient sound interrupt system.

FIG. 9 illustrates a sample data structure storing interrupt sound patterns utilized by the ambient sound interrupt system.

FIG. 10 illustrates a headset in one example configured to implement one or more of the examples described herein.

FIG. 11 illustrates a headset in one example configured to implement one or more of the examples described herein.

FIG. 12 illustrates a perspective view of one example form factor of the headset shown in FIG. 10.

FIG. 13 illustrates a perspective view of one example form factor of the headset shown in FIG. 11.

FIG. 14 is a flow diagram illustrating a method for ambient sound interrupt at a headset speaker in one example.

FIG. 15 is a flow diagram illustrating a method for ambient sound interrupt at a headset speaker in one example.

FIG. 16 is a flow diagram illustrating a method for ambient sound interrupt at a headset speaker in one example.

### DESCRIPTION OF SPECIFIC EMBODIMENTS

Methods and apparatuses for ambient sound enablement in head worn devices are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments.

In one example, a headset includes a processor, a speaker arranged to output audible sound to a headset wearer ear, and an ambient microphone arranged to detect ambient sound and output an ambient sound signal. The headset further includes a memory storing an application executable by the processor configured to process the ambient sound signal and selectively output the ambient sound signal at the speaker.

In one example, a method for operating a headset includes receiving an ambient sound signal from an ambient microphone arranged to detect ambient sound external to a headset, and identifying a pre-determined interrupt condition from the ambient sound signal. The method further includes outputting the ambient sound signal at a headset speaker responsive to identifying the pre-determined interrupt condition.

In one example, one or more non-transitory computer-readable storage media have computer-executable instructions stored thereon which, when executed by one or more computers, cause the one more computers to perform operations including receiving an ambient sound signal from an ambient microphone arranged to detect ambient sound external to a headset. The operations include identifying a pre-determined output interrupt condition from the ambient sound signal, and outputting the ambient sound signal at a headset speaker responsive to identifying the pre-determined interrupt condition.

In one example, a processing circuit performs operations including receiving an ambient sound signal from an ambient microphone arranged to detect ambient sound external to a headset. The processing circuit identifies a pre-determined output interrupt condition from the ambient sound signal. The processing circuit further outputs the ambient sound signal at a headset speaker responsive to identifying the pre-determined interrupt condition.

In one example, an external facing microphone is incorporated on the earcup or insert design of a headset that is programmed to open the receive (Rx) channel when a particular noise is sensed/recognized. In a further implementation, the headset system also opens the Rx channel if the ambient noise level exceeded a predetermined level as a safety feature to inform the intensive user that a possible danger could exist. Advantageously, this functionality operates as an aid for people to more easily contact intensive headset users while engaged and/or as a headset safety feature. In one usage scenario, the headset system would recognize the headset users' name if the parent was summoning the child and open the Rx channel to external conversation.

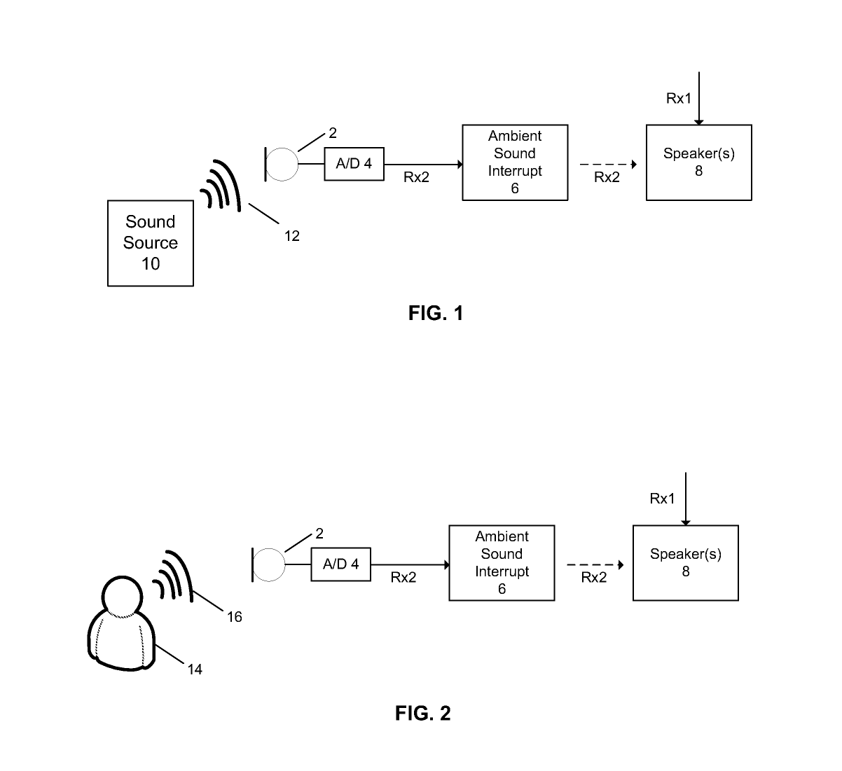

FIG. 1 illustrates a system for ambient sound interrupt in one example. The system includes a microphone 2, analog-to-digital (A/D) converter 4, ambient sound interrupt system 6, and one or more speakers 8 (hereinafter “speaker(s) 8”). Although only a single microphone 2 is illustrated, in a further example an array of two or more microphones may be used. The output of microphone 2 is coupled to analog-to-digital converter 4. Speaker(s) 8 are arranged to output audible sound to a headset wearer ear.

In the example shown in FIG. 1, microphone 2 detects ambient sound 12 from an external sound source 10. The analog signal output from microphone 2 is input to A/D converter 4 to form a digital receive signal Rx2. Receive signal Rx2 may include several signal components, including background noise. Receive signal Rx2 is input to ambient sound interrupt system 6 for processing. In one example, the system is also configured to output a receive audio signal Rx1 at speaker(s) 8 from an interface independent from microphone 2.

Ambient sound interrupt system 6 processes receive signal Rx2 to determine whether to open the receive channel to the speaker(s) 8 and enable (i.e., output) the ambient sound 12 at the speaker(s) 8. In one implementation, ambient sound interrupt system 6 processes receive signal Rx2 to recognize a speech in the ambient sound 12 and selectively output the ambient sound 12 at the speaker(s) 8 when the speech includes a pre-determined interrupt word or interrupt phrase. In one implementation, ambient sound interrupt system 6 processes receive signal Rx2 to determine the ambient sound signal level and selectively output the ambient sound 12 at the speakers(s) 8 when the ambient sound signal level is greater than a pre-determined threshold level. In one implementation, ambient sound interrupt system 6 processes receive signal Rx2 to identify a pre-determined interrupt sound pattern and output the ambient sound 12 at the speaker(s) 8 responsive to an identification of the pre-determined interrupt sound pattern.

In one implementation, ambient sound interrupt system 6 pauses or mutes a current receive audio signal output Rx1 at the speaker(s) 8 prior to an output of the ambient sound 12 at the speaker(s) 8. In a further implementation, ambient sound interrupt system 6 outputs the ambient sound 12 at the speaker(s) 8 in combination with a current receive audio signal Rx1 being output at the speaker(s) 8 using a signal mixer. In various examples, ambient sound 12 detected by the microphone 2 is output at the speaker(s) 8 for a pre-determined amount of time after an interrupt condition is detected, as long as a conversation is detected, or as long as an interrupt condition is detected.

FIG. 2 illustrates a system for ambient sound interrupt in one example of the system shown in FIG. 1. In the example shown in FIG. 2, sound source 10 is an external person 14 and ambient sound 12 is speech 16 from external person 14. Ambient sound interrupt system 6 transmits receive signal Rx2 to speaker(s) 8 for output when the speech 16 includes a pre-determined interrupt word or interrupt phrase, such as the headset wearer name.

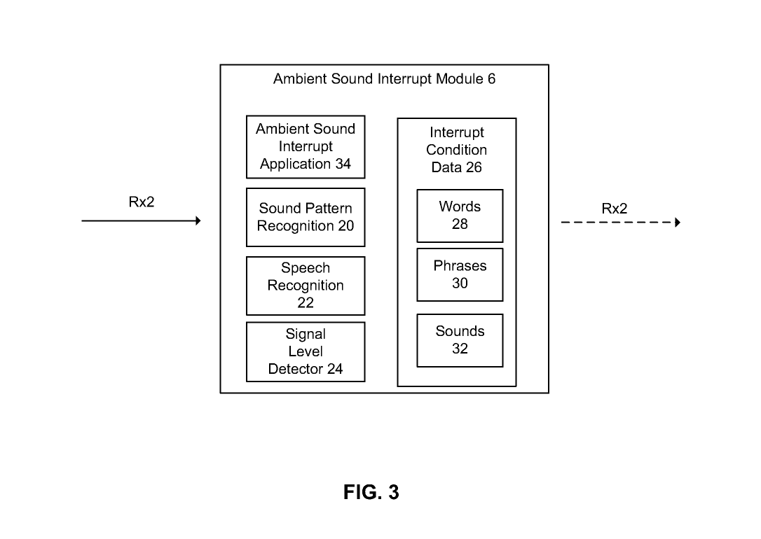

FIG. 3 illustrates an example implementation of the ambient sound interrupt system 6 shown in FIG. 1. Ambient sound interrupt system 6 includes interrupt condition data 26 storing words 28, phrases 30, and sound patterns 32. Ambient sound interrupt system 6 includes a sound pattern recognition module 20, a speech recognition module 22, and a signal level detector 24. Ambient sound interrupt application 34 interfaces with sound pattern recognition module 20, speech recognition module 22, signal level detector 24, and interrupt condition data 26 to implement the processes and functionality described herein.

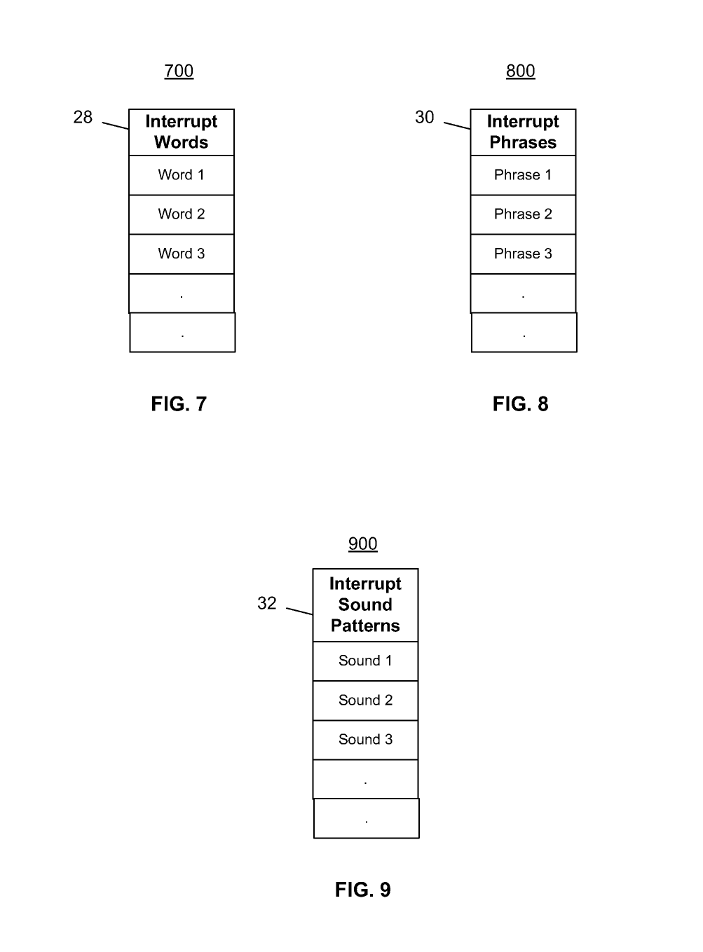

Speech recognition module 22 (also sometimes referred to in the art as “voice recognition”) is operable to recognize words 28 or phrases 30 in receive signal Rx2. FIG. 7 illustrates a sample data structure 700 storing interrupt words 28 utilized by the ambient sound interrupt system 6, and FIG. 8 illustrates a sample data structure 800 storing interrupt phrases 30 utilized by the ambient sound interrupt system 6. Words 28 may be entered into data structure 700 by a user during an initial device (e.g., headset) setup or configuration mode. For example, the user may speak interrupt words 28 (which are converted to text using voice recognition) or enter via alphanumeric text interrupt words 28. In a further example, a person other than the user may speak words 28 during the headset setup or configuration mode, and ambient sound interrupt system 6 further includes a voice print matching module operable to detect the identity of the person speaking. The voice sample obtained during the setup mode is used as the user identifying phrase for later comparison during the voice print matching process. For example, ambient sound interrupt system 6 may determine that the headset wearer's mother may be calling the headset user's name using voice print matching and speech recognition, where the headset user's name is stored as an interrupt word 28 in data structure 700 using the mother's spoken speech. Similarly, the same process may be used to store interrupt phrases 30 in data structure 800. In a further example, interrupt words 28 and interrupt phrases 30 may be pre-stored at the manufacturer. Interrupt words 28 and interrupt phrases 30 can be any spoken word or phrase desired to interrupt the headset wearer when detected. For example, interrupt words 28 and interrupt phrases 30 may include words and phrases such as names, emergency words or phrases, and command words or phrases.

Sound pattern recognition module 20 is operable to recognize sound patterns 32 in receive signal Rx2. FIG. 9 illustrates a sample data structure 900 storing interrupt sound patterns 32 utilized by the ambient sound interrupt system. As with interrupt words 28 and interrupt phrases 30, interrupt sound patterns 32 may be entered (e.g., played and recorded) or selected by the user during a headset configuration mode or at the manufacturer. For example, interrupt sound patterns 32 may include sounds which indicate danger, such as fire alarms, horns, police sirens, etc. Sound patterns 32 may also include ring tones. Signal level detector 24 is operable to detect a signal level of receive signal Rx2.

In one example, ambient sound interrupt system 6 is implemented on a headset. In a further example, ambient sound interrupt system 6 may be implemented on a variety of mobile devices. Ambient sound interrupt system 6 may be a distributed system. Components of ambient sound interrupt system 6 may be implemented on a single host device or across several devices, including cloud based implementations. Example devices include headsets, mobile phones, personal computers, and network servers.

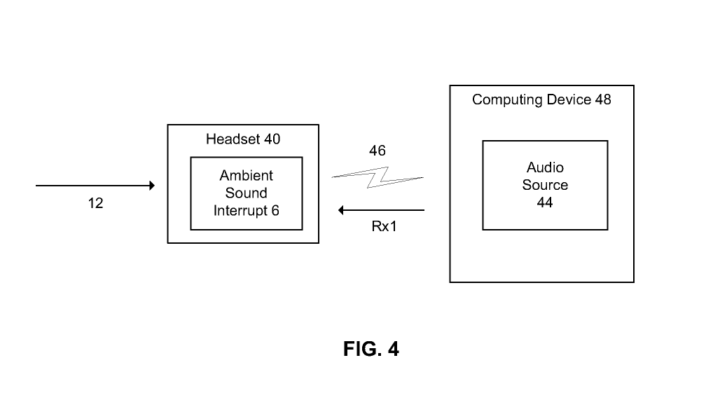

FIG. 4 illustrates an example implementation of the system for ambient sound interrupt shown in FIG. 1. In this implementation, ambient sound interrupt system 6 is disposed at a headset 40. Headset 40 is connectible to a computing device 48 having an audio source 44 via a communications link 46, and the headset user receives a receive audio signal Rx1 from computing device 48. Although shown as a wireless link, communications link 46 may be a wired or wireless link. For example, computing device 48 may be a notebook computer, smartphone, digital music player device, or personal computer. Ambient sound interrupt system 6 receives and process ambient sound 12 as described herein.

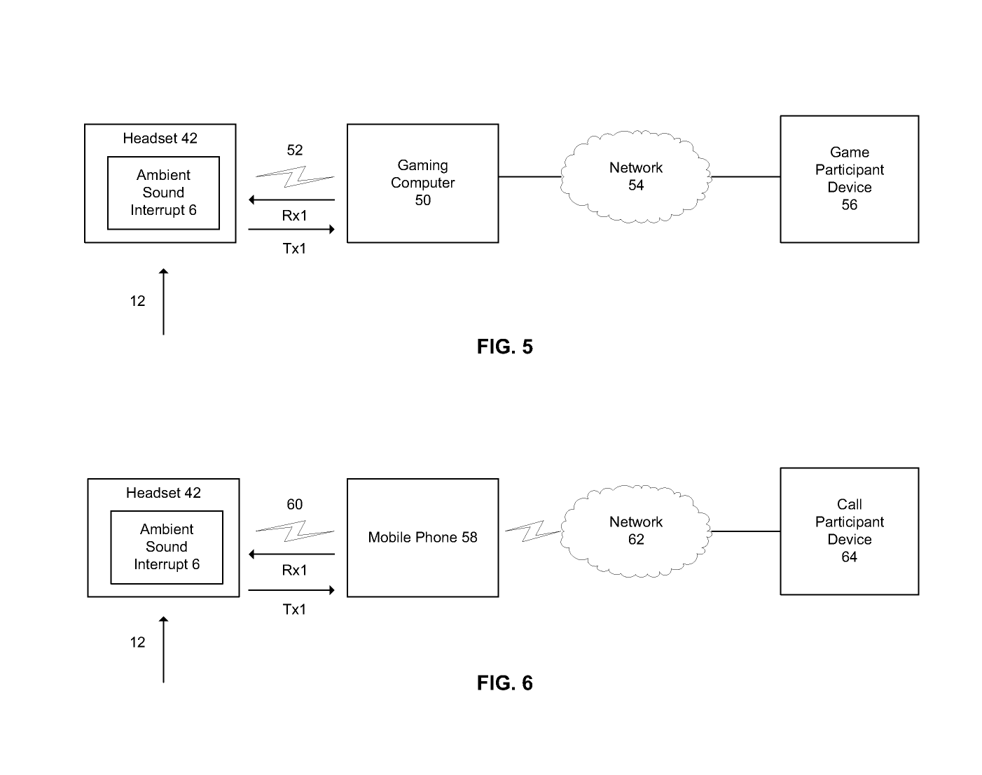

FIG. 5 illustrates a further example implementation of the system for ambient sound interrupt shown in FIG. 1. In this implementation, ambient sound interrupt system 6 is an application disposed at and executable on a headset 42 in communication with a gaming computer 50 via a communications link 52, which may be a wired or wireless communications link. Gaming computer 50 is connectible to a game participant device 56 via a network 54. For example, network 54 may be an Internet Protocol (IP) network. Gaming computer 50 may, for example, be a game console device, personal computer, or smartphone. In operation, headset 42 sends a transmit audio signal Tx1 to gaming computer 50 and receives a receive audio signal Rx1 from gaming computer 50 over communications link 52. Ambient sound interrupt system 6 receives and process ambient sound 12 as described herein.

FIG. 6 illustrates a further example implementation of the system for ambient sound interrupt shown in FIG. 1. In this implementation, ambient sound interrupt system 6 is an application disposed at and executable on a headset 42 in communication with a mobile phone 58 via a communications link 60, which may be a wired or wireless communications link. Mobile phone 58 is connectible to a call participant device 64 via a network 62. For example, network 62 may be a cellular communications network. Mobile phone 58 may, for example, be a smartphone. In operation, headset 42 sends a transmit audio signal Tx1 to mobile phone 58 and receives a receive audio signal Rx1 from mobile phone 58 over communications link 60. Ambient sound interrupt system 6 receives and process ambient sound 12 as described herein. The headset 42 and mobile phone 58 may utilize the communications link 60 such as Bluetooth so that the user can conduct calls using headset 42 with mobile phone 58 over a cellular communications or other network.

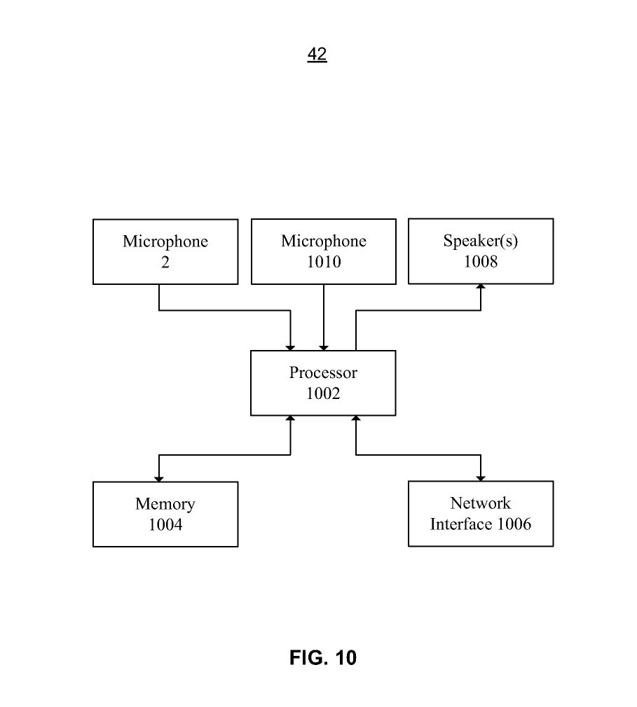

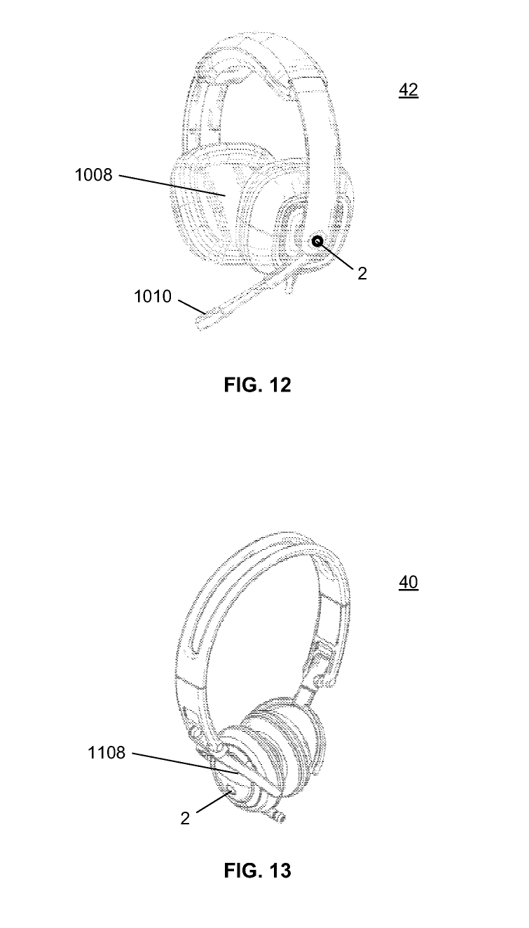

FIG. 10 illustrates a headset 42 in one example configured to implement one or more of the examples described herein. Examples of headset 42 include circumaural headsets, telecommunications headsets, and stereo headphones. The term “headset” as used herein encompasses any head-worn device. For example, headset 42 may take the form factor as shown in FIG. 12.

In one example, a headset 42 includes a microphone 2, microphone 1010, speaker(s) 1008, a memory 1004, and a network interface 1006 operable to receive a receive audio signal to be output at the speaker and transmit a transmit audio signal (e.g., to a call participant). Headset 42 includes a digital-to-analog converter (D/A) coupled to speaker(s) 1008 and an analog-to-digital converter (A/D) coupled to microphone 1010. In one example, the network interface 1006 is a wireless transceiver or a wired network interface. In one implementation, speaker(s) 1008 include a first speaker worn on the user left ear to output a left channel of a stereo signal and a second speaker worn on the user right ear to output a right channel of the stereo signal.

Headset 42 includes an ambient microphone 2 dedicated to and optimized to detect ambient sound, which may include background noise, sounds, user voices, etc. For example, microphone 2 is placed on the headset 42 in a position so that detection of a headset wearer voice is minimized while detection of ambient sound is maximized. FIG. 12 illustrates a perspective view of a headset 42 embodiment. In the example shown in FIG. 12, the ambient microphone 2 is placed on an outer side of the headset housing. Microphone 1010 is placed in the typical position at the end of the headset boom.

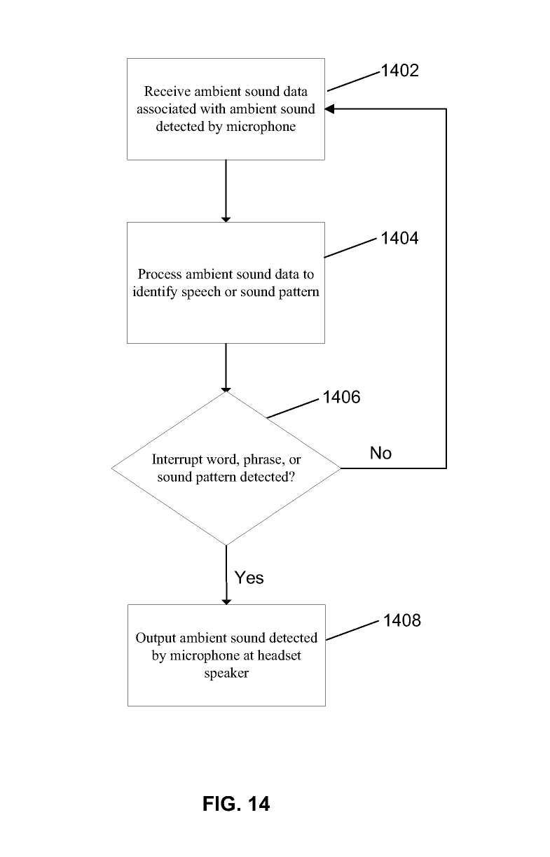

Memory 1004 represents an article that is computer readable. For example, memory 1004 may be any one or more of the following: random access memory (RAM), read only memory (ROM), flash memory, or any other type of article that includes a medium readable by processor 1002. Memory 1004 can store computer readable instructions for performing the execution of the various method embodiments of the present invention. In one example, the processor executable computer readable instructions are configured to perform a process such as that shown in FIGS. 14-16. Computer readable instructions may be loaded in memory 1004 for execution by processor 1002. In one example, processor 1002 implement operations that detect ambient sound at microphone 2 and selectively initiates a process by which the ambient sound is output at speaker(s) 1008.

Network interface 1006 allows device 1000 to communicate with other devices. Network interface 1006 may include a wired connection or a wireless connection. Network interface 1006 may include, but is not limited to, a wireless transceiver, an integrated network interface, a radio frequency transmitter/receiver, a USB connection, or other interfaces for connecting headset 42 to a telecommunications network such as a Bluetooth network, cellular network, the PSTN, or an IP network.

In one example operation, the headset 42 includes a processor 1002 configured to process the ambient sound signal and selectively output the ambient sound signal at the speaker(s) 1008. In one example, the processor 1002 is configured to process the ambient sound signal by recognizing a speech in the ambient sound signal and configured to selectively output the ambient sound signal at the speaker(s) 1008 when the speech includes a pre-determined interrupt word or interrupt phrase, such as a headset wearer name. The processor 1002 may also be configured process the ambient sound signal to identify a pre-determined interrupt sound pattern and output the ambient sound signal at the speaker(s) 1008 responsive to an identification of the pre-determined interrupt sound pattern. In a further example, the processor 1002 is configured to process the ambient sound signal by determining an ambient sound signal level and configured to selectively output the ambient sound signal at the speaker(s) 1008 when the ambient sound signal level is greater than a pre-determined threshold level. Where the processor 1002 determines that the ambient sound should be output at speaker(s) 1008, the processor is configured to pause or mute a current receive audio signal output at the speaker prior to an output of the ambient sound signal at the speaker(s) 1008, or alternatively output the ambient sound signal at the speaker(s) 1008 in combination with a current receive audio signal output at the speaker(s) 1008. In a further example, the processor 1002 is configured to only pause, reduce or mute the volume of the current receive audio signal output at the speaker when the processor 1002 identifies a pre-determined interrupt condition, and the processor 1002 does not output the ambient sound signal at the headset speaker (i.e., does not open the receive channel to the headset speaker).

In a further example, headset 42 does not include microphone 2, but only microphone 1010. In this example, microphone 1010 is operable as the ambient microphone performing functions of an ambient microphone described herein. Microphone 1010 is also operable to detect a headset wearer's voice, such as when headset used for voice communications. When not used to receive a headset user's voice, microphone 1010 is optimized to detect ambient sound, which may include background noise, sounds, user voices, etc.

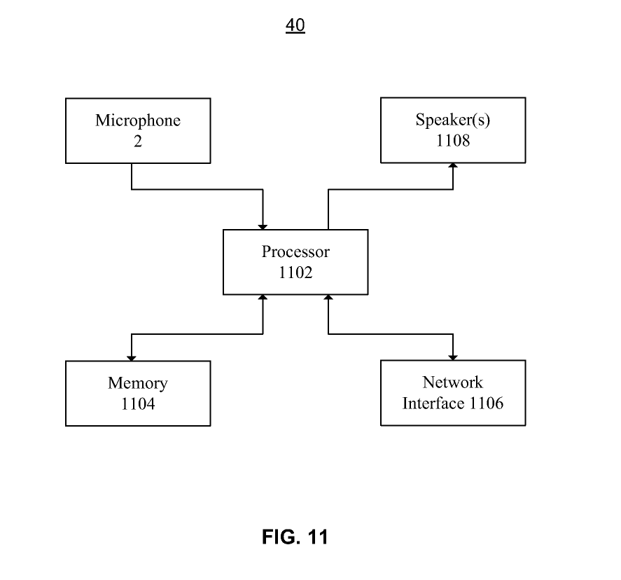

FIG. 11 illustrates a headset 40 in a further example configured to implement one or more of the examples described herein. Headset 40 is substantially similar to headset 42 in FIG. 10 except that headset 40 does not include microphone 1010, but only microphone 2. Microphone 2 may be optimized to detect ambient sound. FIG. 13 illustrates a perspective view of an embodiment of headset 40 shown in FIG. 11. In the example shown in FIG. 13, microphone 2 is placed on an outer side of the headset housing.

FIG. 14 is a flow diagram illustrating a method for ambient sound interrupt at a headset speaker in one example. At block 1402, ambient sound data associated with ambient sound detected by a microphone is received.

At block 1404, the ambient sound data is processed to identify a speech or sound pattern. In one example, identifying the speech includes recognizing a pre-determined interrupt word or interrupt phrase in the ambient sound data. At decision block 1406, it is determined whether an interrupt word, phrase, or sound pattern is detected. If no at decision block 1406, the process returns to block 1402.

If yes at decision block 1406, at block 1408, ambient sound detected by the microphone is output at the headset speaker. In various examples, ambient sound detected by the microphone is output at the headset speaker for a pre-determined amount of time, as long as a conversation is detected, or as long as an interrupt condition is detected. Prior to outputting the ambient sound (i.e., interrupting the user), a receive audio signal currently being output at the headset speaker may be paused or muted. In a further example, the ambient sound is combined with the current receive audio signal and both are simultaneously output at the headset speaker.

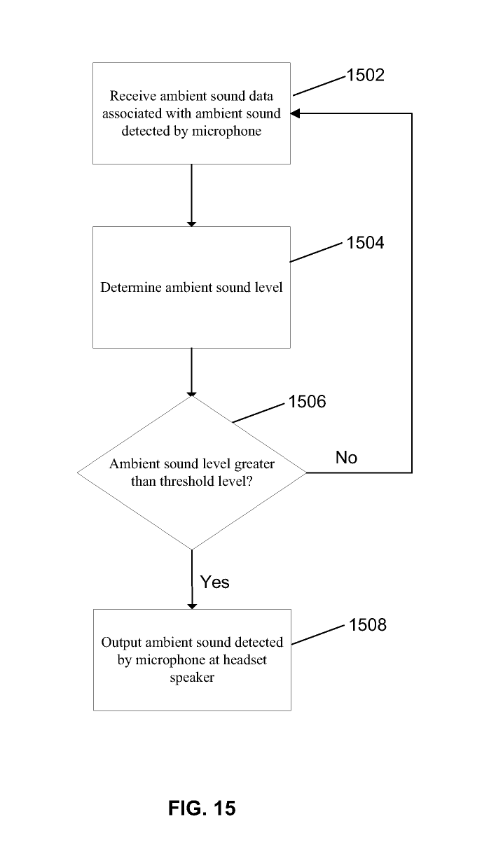

FIG. 15 is a flow diagram illustrating a method for ambient sound interrupt at a headset speaker in one example. At block 1502, ambient sound data associated with ambient sound detected by a microphone is received.

At block 1504, the ambient sound data is processed to determine the ambient sound level. At decision block 1506, it is determined whether the ambient sound level is greater than a predetermined threshold level. For example, the predetermined threshold level may be in the range of 80-90 dB. If no, the process returns to block 1502.

If yes at decision block 1506, at block 1508, ambient sound detected by the microphone is output at the headset speaker. In various examples, ambient sound detected by the microphone is output at the headset speaker for a pre-determined amount of time, as long as a conversation is detected, or as long as an interrupt condition is detected. Prior to outputting the ambient sound (i.e., interrupting the user), a receive audio signal currently being output at the headset speaker may be paused or muted. In a further example, the ambient sound is combined with the current receive audio signal and both are output at the headset speaker.

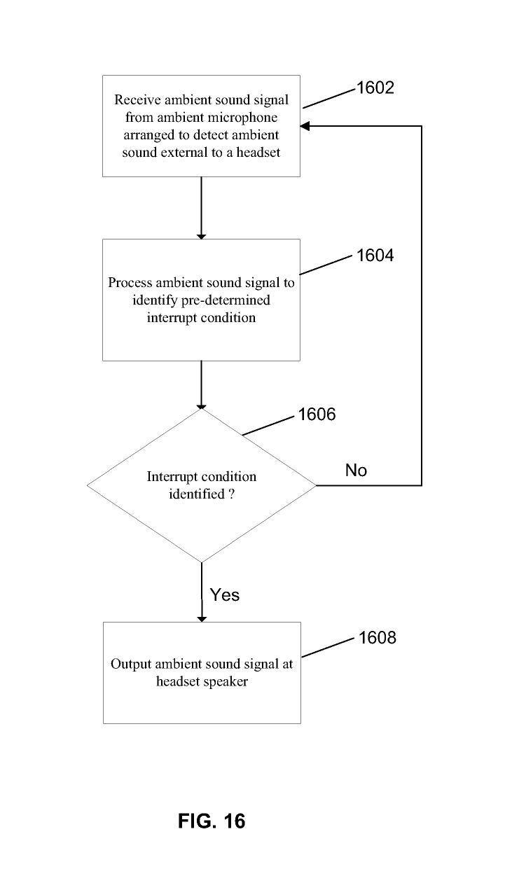

FIG. 16 is a flow diagram illustrating a method for ambient sound interrupt at a headset speaker in one example. At block 1602, an ambient sound signal from an ambient microphone is detected, the ambient microphone arranged to detect ambient sound external to a headset.

At block 1604, the ambient sound signal is processed to identify a pre-determined interrupt condition. In one example, identifying the pre-determined interrupt condition includes recognizing a pre-determined interrupt word or interrupt phrase in the ambient sound signal. In one example, identifying the pre-determined interrupt condition includes determining whether an ambient sound signal level is greater than a predetermined threshold level. In one example, identifying the pre-determined interrupt condition includes identifying a pre-determined interrupt sound pattern in the ambient sound signal.

At decision block 1606, it is determined whether an interrupt condition has been identified. If no at decision block 1606, the process returns to block 1602. If yes at decision block 1606, at block 1608, the ambient sound signal is output at the headset speaker. In various examples, the ambient sound signal is output at the headset speaker for a pre-determined amount of time after the interrupt condition is identified, as long as a conversation is detected, or as long as an interrupt condition is detected. Prior to outputting the ambient sound signal (i.e., interrupting the user), a receive audio signal currently being output at the headset speaker may be paused or muted. In a further example, the ambient sound signal is combined with the current receive audio signal and both are simultaneously output at the headset speaker.

While the exemplary embodiments of the present invention are described and illustrated herein, it will be appreciated that they are merely illustrative and that modifications can be made to these embodiments without departing from the spirit and scope of the invention. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. A headset comprising:
a processor;
a speaker arranged to output audible sound to a headset wearer ear;
an ambient microphone arranged to detect ambient sound and output an ambient sound signal; and
a memory storing an application executable by the processor configured to process the ambient sound signal and selectively output the ambient sound signal at the speaker.

2. The headset of claim 1, wherein the application is configured to process the ambient sound signal by recognizing a speech in the ambient sound signal and configured to selectively output the ambient sound signal at the speaker when the speech comprises a pre-determined interrupt word or interrupt phrase.

3. The headset of claim 2, wherein the pre-determined interrupt word or interrupt phrase comprises a headset wearer name.

4. The headset of claim 1, wherein the application is configured to process the ambient sound signal to identify a pre-determined interrupt sound pattern and output the ambient sound signal at the speaker responsive to an identification of the pre-determined interrupt sound pattern.

5. The headset of claim 1, further comprising a microphone arranged to receive a headset wearer speech.

6. The headset of claim 1, further comprising an interface configured to receive a receive audio signal to be output at the speaker.

7. The headset of claim 1, wherein the application is configured to process the ambient sound signal by determining an ambient sound signal level and configured to selectively output the ambient sound signal at the speaker when the ambient sound signal level is greater than a pre-determined threshold level.

8. The headset of claim 1, wherein the application is configured to pause or mute a current receive audio signal output at the speaker prior to an output of the ambient sound signal at the speaker.

9. The headset of claim 1, wherein the application is configured to output the ambient sound signal at the speaker in combination with a current receive audio signal output at the speaker.

10. The headset of claim 1, wherein the ambient microphone is further arranged to detect a headset wearer's speech.

11. A method for operating a headset comprising:
receiving an ambient sound signal from a microphone arranged to detect ambient sound external to a headset;
identifying a pre-determined interrupt condition from the ambient sound signal; and
outputting the ambient sound signal at a headset speaker responsive to identifying the pre-determined interrupt condition.

12. The method of claim 11, wherein identifying the pre-determined interrupt condition comprises recognizing a pre-determined interrupt word or interrupt phrase in the ambient sound signal.

13. The method of claim 12, wherein the pre-determined interrupt word or interrupt phrase is a name.

14. The method of claim 11, wherein identifying the pre-determined interrupt condition comprises determining an ambient sound signal level is greater than a predetermined threshold level.

15. The method of claim 11, wherein identifying the pre-determined interrupt condition comprises identifying a pre-determined interrupt sound pattern in the ambient sound signal.

16. The method of claim 11, further comprising pausing or muting a current output of a receive audio signal at the headset speaker prior to outputting the ambient sound signal.

17. The method of claim 11, wherein outputting the ambient sound signal at the headset speaker comprises outputting the ambient sound signal together with a receive audio signal at the headset speaker.

18. One or more non-transitory computer-readable storage media having computer-executable instructions stored thereon which, when executed by one or more computers, cause the one more computers to perform operations comprising:
receiving an ambient sound signal from a microphone arranged to detect ambient sound external to a headset;
identifying a pre-determined interrupt condition from the ambient sound signal; and
outputting the ambient sound signal at a headset speaker responsive to identifying the pre-determined interrupt condition.

19. The one or more non-transitory computer-readable storage media of claim 18, wherein identifying the pre-determined interrupt condition comprises recognizing a pre-determined interrupt word or interrupt phrase in the ambient sound signal.

20. The one or more non-transitory computer-readable storage media of claim 18, wherein identifying the pre-determined interrupt condition comprises determining an ambient sound signal level is greater than a predetermined threshold level.

21. The one or more non-transitory computer-readable storage media of claim 18, wherein identifying the pre-determined interrupt condition comprises identifying a pre-determined sound in the ambient sound signal.

22. The one or more non-transitory computer-readable storage media of claim 18, wherein the operations further comprise: pausing or muting a current output of a receive audio signal at the headset speaker prior to outputting the ambient sound signal.

23. The one or more non-transitory computer-readable storage media of claim 18, wherein outputting the ambient sound signal at the headset speaker comprises outputting the ambient sound signal together with a receive audio signal at the headset speaker.

24. One or more non-transitory computer-readable storage media having computer-executable instructions stored thereon which, when executed by one or more computers, cause the one more computers to perform operations comprising:
receiving an ambient sound signal from a microphone;
identifying a pre-determined interrupt condition from the ambient sound signal; and
pausing, reducing or muting a volume of a current receive signal output at a headset speaker responsive to identifying the pre-determined interrupt condition.

25. The one or more non-transitory computer-readable storage media of claim 24, further comprising outputting the ambient sound signal at a headset speaker responsive to identifying the pre-determined interrupt condition.

26. The one or more non-transitory computer-readable storage media of claim 24, wherein identifying the pre-determined interrupt condition comprises recognizing a pre-determined interrupt word or interrupt phrase in the ambient sound signal.

27. The one or more non-transitory computer-readable storage media of claim 24, wherein identifying the pre-determined interrupt condition comprises determining an ambient sound signal level is greater than a predetermined threshold level.

28. The one or more non-transitory computer-readable storage media of claim 24, wherein identifying the pre-determined interrupt condition comprises identifying a pre-determined sound in the ambient sound signal.
